(19) United States
(12) Patent Application Publication
(10) Pub. No.: US 2014/0066059 A1
(43) Pub. Date: Mar. 6, 2014

(54) METHOD AND APPARATUS DETERMINING WHITE SPACE INFORMATION

(71) Applicants: Basavaraj Patil, Coppell, TX (US); Scott Probasco, Bedford, TX (US); Padam Kafle, Coppell, TX (US); Prabodh Varshney, Coppell, TX (US)

(72) Inventors: Basavaraj Patil, Coppell, TX (US); Scott Probasco, Bedford, TX (US); Padam Kafle, Coppell, TX (US); Prabodh Varshney, Coppell, TX (US)

(73) Assignee: NOKIA CORPORATION, Espoo (FI)

(21) Appl. No.: 13/601,518

(22) Filed: Aug. 31, 2012

(51) Int. Cl. H04W 48/16

(52) U.S. Cl. CPC H04W 48/16
USPC 455/434

(57) ABSTRACT

A method, apparatus and computer program product are provided to obtain white space information regarding one or more white space channels that are available at the current location of a mobile terminal and one or more service providers that offer connectivity utilizing the white space spectrum. In the context of a method performed, for example, by an access network discovery and selection function device, a location of a mobile terminal is determined and, based on the location of the mobile terminal, white space information is obtained. The method also causes the white space information to be provided to the mobile terminal, such as by utilizing a device management protocol. A corresponding apparatus and computer program product are also provided.

### TECHNOLOGICAL FIELD

An example embodiment of the present invention relates generally to wireless communications technology and, more particularly, to a method, apparatus and computer program product for determining white space information.

### BACKGROUND

Multiple generations of cellular networks are in existence globally. These networks include second generation (2G), third generation (3G), 3.5G and fourth generation (4G) networks which are based on cellular technologies such as general packet radio service (GPRS), enhanced data for global system for mobile (GSM) evolution (EDGE), wideband code division multiple access (WCDMA), high speed packet access (HSPA) and long term evolution (LTE). These networks have been deployed in different frequency bands of the spectrum depending upon the country of deployment and the regulatory environment. However, as the demand for data services continues to grow, the capacity of these cellular networks is sometimes being strained. As such, either additional frequency bands of the spectrum must be made available and networks must be deployed on these additional bands to meet the growing demand for data and other services or data and other services must be provided using other types of access networks, that is, non-cellular access networks, such as access networks utilizing WiFi and similar technologies.

Some regulatory bodies, such as the Federal Communications Commission (FCC) in the United States and the Office of Communications (OFCOM) in the United Kingdom, have made a portion of the spectrum that is otherwise reserved for use by television stations, but that has largely been unused, at least in certain geographic regions, available for use for communications. This portion of the spectrum that is made available is termed television white space and may be made available in the television white space frequency bands. In this regard, the primary user of the television white space spectrum are television stations that have purchased the licenses for certain white space frequency bands. However, the television white space spectrum may be unused or used only in the partial manner by the television stations such that unused channels within the television white space spectrum may be used by secondary users, such as by mobile terminals, so long as the use of the otherwise unused white space channels by the secondary users does not create interference for the television stations. As such, a requirement to utilize a television white space frequency band for communications is to determine a channel within the white space frequency band that is unused and is therefore available at a given location for use in an unlicensed manner by secondary users.

With respect to television white space networks, a white space spectrum database may be queried in order to determine the available white space channels at a particular location. The white space database may be queried via an interface having internet connectivity, such as a cellular interface or a WiFi interface. Thus, in order to utilize a white space channel, a mobile terminal, such as a multi-radio device that includes WiFi and white space radios in addition to a cellular radio, may query a white space spectrum database to determine if there are any available white space channels for use at its current location. This process of querying the white space spectrum database and receiving and processing the information regarding the available white space channels may drain the battery resources of the mobile terminal, such as a cellular telephone, a smart phone, a tablet computer or the like. The querying of the white space spectrum database and the receipt of the white space information from the white space spectrum database may also be considered to be usage of a data service by the mobile terminal, which may be limited or the subject of a charge by at least some network operators.

The white space information provided by a white space spectrum database may indicate that one or more white space channels are unused and are available at the location of the mobile terminal, but the white space information that is returned by the white space spectrum database may not provide information regarding a service provider that offers connectivity service using the available white space channel at the particular location. As such, a mobile terminal in receipt of the white space information may still have difficulty utilizing an available white space channel as a result of an inability to identify a service provider that supports connectivity for the available white space channel.

### BRIEF SUMMARY

A method, apparatus and computer program product are provided according to an example embodiment in order to obtain white space information regarding one or more white space channels that are available and one or more service providers that offer connectivity utilizing the white space spectrum. By providing information regarding the service providers, a mobile terminal may more readily utilize a white space channel that is available so as to offload, for example, data services from the cellular network. Further, the method, apparatus and computer program product of an example embodiment may provide a mobile terminal with white space information in a manner that is efficient for the mobile terminal by reducing the signaling required by the mobile terminal and the power consumed by the mobile terminal to conjunction with obtaining the white space information. Instead, the method, apparatus and computer program product of an example embodiment may utilize an access network discovery and selection function device in order to interact with a white space database and to provide the white space information to the mobile terminal.

The one embodiment, a method is provided that includes determining, with a processor, a location of a mobile terminal and, based on the location of mobile terminal, obtaining white space information. The white space information is regarding one or more service providers that offer connectivity utilizing a white space spectrum and information regarding one or more white space channels that are available via the one or more service providers. The method of this embodiment also causes the white space information to be provided to the mobile terminal, such as by utilizing a device management protocol.

The method of one embodiment may obtain white space information by causing a query, including the location of mobile terminal, to be issued to a white space database. In response to the query, the method of this embodiment receives from the white space database the information regarding one or more white space channels that are available at the location of the mobile terminal. In one embodiment, the obtaining of the white space information further includes receiving the information regarding one or more service providers that offer connectivity via the one or more white space channels that are available at the location of the mobile terminal in a manner in which the information regarding the one or more service providers is also received from the white space database in response to the query. In another embodiment, the obtaining of the white space information further includes obtaining the information regarding one or more service providers that offer connectivity via the one or more white space channels that are available at the location mobile terminal following receipt of the information from the white space database regarding the one or more white space channels that are available at the location of the mobile terminal. In this embodiment, the information regarding the one or more service providers is obtained independent of the white space database.

The method may determine the location the mobile terminal in various manners including by receiving information regarding the location the mobile terminal from at least one of a home subscriber service or a home location register. In this embodiment, the determination of the location of the mobile terminal may also include determining latitude and longitude coordinates for the mobile terminal based upon the information regarding the location of the mobile terminal from at least one of the home subscriber service or the home location register.

In another embodiment, an apparatus is provided that includes at least one processor and at least one memory including computer program code with the memory and the computer program code configured to, with the at least one processor, cause the apparatus at least to determine the location the mobile terminal and, based on the location of the mobile terminal, obtain white space information. The white space information is regarding one or more service providers that offer connectivity utilizing a white space spectrum and information regarding one or more white space channels that are available via the one or more service providers. The at least one memory and the computer program code are also configured to, with the at least one processor, cause the apparatus of this embodiment to cause the white space information to be provided to the mobile terminal. The apparatus of one embodiment may also include a communication interface configured to communicate with the mobile terminal. The apparatus may be embodied, for example, by an access network discovery and selection function device.

The at least one memory and the computer program code of one embodiment are configured to, with the at least one processor, cause the apparatus to obtain white space information by causing a query, including the location the mobile terminal, to be issued to a white space database and, in response to the query, receiving from the white space database the information regarding one or more white space channels that are available at the location of the mobile terminal. In one embodiment, the at least one memory and the computer program code are configured to, with the at least one processor, cause the apparatus to obtain white space information by receiving the information regarding one or more service providers that offer connectivity via the one or more white space channels that are available at the location the mobile terminal. In this regard, the information regarding the one or more service providers is also received from the white space database in response to the query. In another embodiment, the at least one memory and the computer program code are configured to, with the at least one processor, cause the apparatus to obtain television white space information by obtaining the information regarding one or more service providers that offer connectivity via the one or more white space channels that are available at the location of the mobile terminal following receipt of the information from the white space database regarding the one or more white space channels that are available at the location of the mobile terminal. In this regard, the information regarding the one or more service providers is obtained independent of the white space database. The at least one memory and the computer program code of one embodiment are configured to, with the at least one processor, cause the apparatus to determine the location of the mobile terminal by receiving information regarding the location of the mobile terminal from at least one of a home subscriber server or a home location register.

In a further embodiment, a computer program product is provided that includes computer executable program code stored on a non-transitory computer readable storage medium with the computer executable program code being configured, upon execution, to determine a location of a mobile terminal and, based on the location of the mobile terminal, to obtain white space information. The white space information is regarding one or more service providers that offer connectivity utilizing a white space spectrum and information regarding one or more white space channels that are available via the one or more service providers. The computer executable program code of this embodiment is also configured, upon execution, to cause the white space information to be provided to the mobile terminal.

In yet another embodiment, an apparatus is provided that includes means for determining a location to the mobile terminal and, based on the location of the mobile terminal, means for obtaining white space information. The white space information is regarding one or more service providers that offer connectivity utilizing a white space spectrum and information regarding one or more white space channels that are available via the one or more service providers. The apparatus of this embodiment also includes means for causing the white space information to be provided to the mobile terminal.

In one embodiment, a method is provided that includes receiving white space information from an access network discovery and selection function device regarding one or more service providers that offer connectivity utilizing a white space spectrum and information regarding one or more white space channels that are available via the one or more service providers. The white space information may be received in one embodiment without requiring a mobile terminal to query a white space database. The method of this embodiment also includes determining, with the processor, whether to utilize a white space channel that is available via a respective service provider.

In another embodiment, an apparatus is provided that includes at least one processor and at least one memory including computer program code with the at least one memory and the computer program code configured to, with the at least one processor, cause the apparatus at least to receive white space information from an access network discovery and selection function device regarding one or more service providers that offer connectivity utilizing a white space spectrum and information regarding one or more white space channels that are available via the one or more service providers. The white space information may be received in one embodiment without requiring a mobile terminal to query a white space database. The at least one memory and the computer program code are also configured to, with the at least one processor, cause the apparatus of this embodiment to determine whether to utilize the white space channel that is available via a respective service provider. The apparatus of this embodiment may be embodied, for example, by a mobile terminal.

In a further embodiment, a computer program product is provided that includes computer executable program code stored on a non-transitory computer readable storage medium with the computer executable program code being configured, upon execution, to receive white space information from an access network discovery and selection function device regarding one or more service providers that offer connectivity utilizing a white space spectrum and information regarding one or more white space channels that are available via the one or more service providers. The computer executable program code of this embodiment is also configured, upon execution, to determine whether to utilize a white space channel that is available via respective service provider.

In yet another embodiment, an apparatus is provided that includes means for receiving white space information from an access network discovery and selection device regarding one or more service providers that offer connectivity utilizing a white space spectrum and information regarding one or more white space channels that are available via the one or more service providers. The apparatus of this embodiment also includes means for determining whether to utilize a white space channel that is available via a respective service provider.

### BRIEF DESCRIPTION OF THE DRAWINGS

Having thus described example embodiments of the present disclosure in general terms, reference will now be made to the accompanying drawings, which are not necessarily drawn to scale, and wherein:

FIG. 1 is a schematic representation of a system including, among other elements, an access network discovery and selection function device that may be configured in accordance with an example embodiment of the present invention;

FIG. 2 is a block diagram of an apparatus that may be embodied by an access network discovery and selection function device and/or a mobile terminal and that may be specifically configured in accordance with an example embodiment of the present invention;

FIG. 3 is a signal flow diagram in accordance with an example embodiment of the present invention;

FIG. 4 is a flow chart illustrating the operations performed by an apparatus embodied by an access network discovery and selection function device in accordance with an example embodiment of the present invention; and

FIG. 5 is a flow chart illustrating the operations performed by an apparatus embodied by a mobile terminal in accordance with an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory, physical storage medium (e.g., volatile or non-volatile memory device), can be differentiated from a “computer-readable transmission medium,” which refers to an electromagnetic signal.

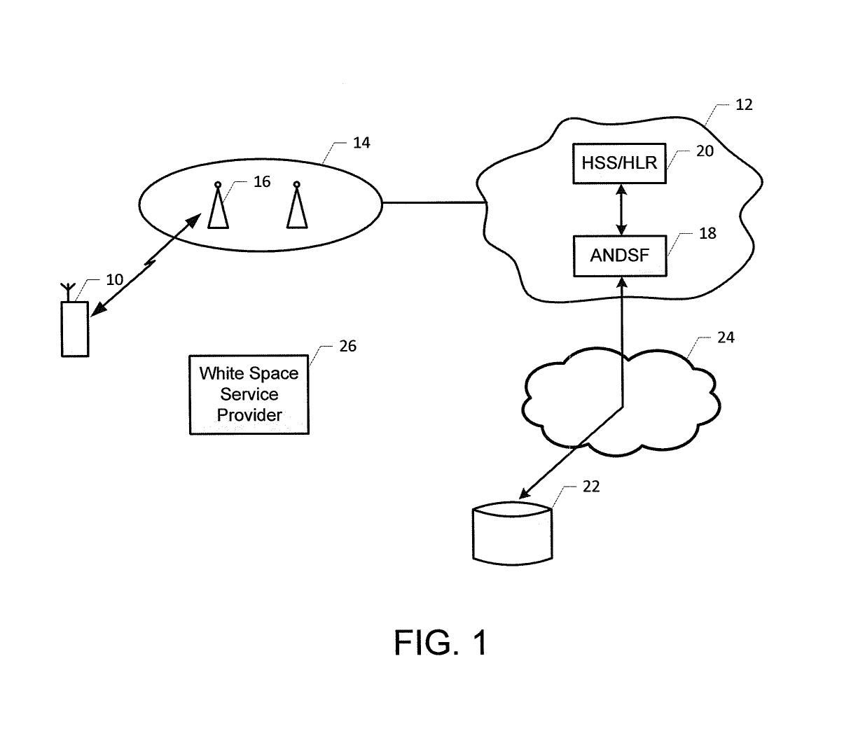

Referring now to FIG. 1, a system that may support communications with a mobile terminal 10 is illustrated. In this regard, a mobile terminal may be any of a variety of mobile communications devices including, for example, a portable computing device, e.g., a laptop computer or a tablet computer, a mobile telephone, a smartphone, a personal digital assistant (PDA), a universal serial bus (USB) or other dongle, a personal computer (PC) emulator card, a pager, a mobile television, a gaming device, an electronic book reader, a camera, an audio/video player, a radio, a global positioning system (GPS) device, or any combination of the aforementioned, and other types of communications devices. As shown in FIG. 1, the mobile terminal may be configured to communicate with a core network 12 via an access network 14. The core network may be any of a variety of different networks including, for example, 2G, 3G, 3.5G and 4G networks which are based on cellular technologies such as GPRS, EDGE, WCDMA, HSPA, LTE and the like. The access network of one embodiment may be a radio access network, such as a cellular radio access network. As such, the access network may include one or more base stations 16, such as one or more node Bs, evolved node Bs (eNBs), access points, relay nodes or the like. The base stations are configured to communicate with the mobile terminal and, in turn, to support communications involving the mobile terminal with the core network.

The core network 12 may include a variety of devices that interoperate to provide the network functionality. In this regard, the core network may include an access network discovery and selection function (ANDSF) device 18 that is configured to provide the mobile terminal 10 with information regarding networks, e.g., access networks such as WiFi networks or other wireless local area networks (WLANs), that are available at the current location of the mobile terminal. In addition to identifying the available networks, the ANDSF device may provide information regarding operator policies that are relevant to the available networks. Based upon the information provided by the ANDSF device, the mobile terminal may access another network, such as a Wi-Fi network. The core network may also include a home subscriber server (HSS) and/or a home location register (HLR) 20. Among other functions, the HSS/HLR maintains a record of various parameters associated with the mobile terminal including the current location of the mobile terminal.

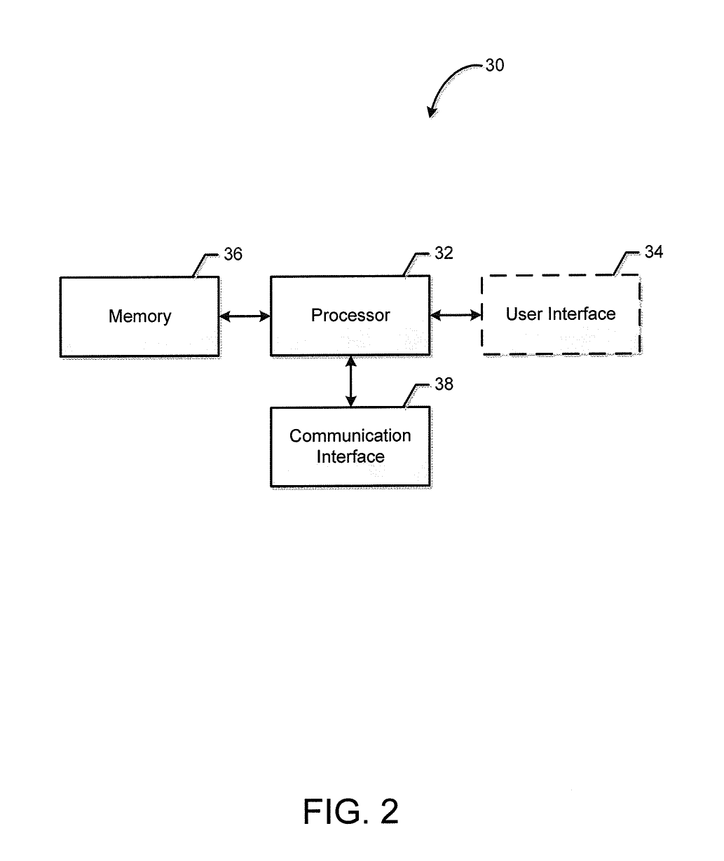

Referring now to FIG. 2, an apparatus 30 that may be embodied by the ANDSF device 18 or by a mobile terminal 10 and that may be specifically configured in accordance with an example embodiment of the present invention is illustrated. It should be noted, however, that the devices or elements described below may not be mandatory and thus some may be omitted in certain embodiments. With respect to FIG. 2, the apparatus of the illustrated embodiment may include or otherwise be in communication with a processor 32, a memory device 34, a communication interface 36 and optionally a user interface 38. The memory device may comprise, for example, a non-transitory memory, such as one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, applications, instructions or the like for enabling the apparatus to carry out various functions in accordance with example embodiments of the present invention. For example, the memory device could be configured to buffer input data for processing by the processor. Additionally or alternatively, the memory device could be configured to store instructions for execution by the processor.

The apparatus 30 may, in some embodiments, be an ANDSF device 18 or a mobile terminal 10 as described above. However, in some embodiments, the apparatus may be embodied as a chip or chip set (which may in turn be employed at one of the devices mentioned above). In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry comprised thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 32 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may comprise one or more processing cores configured to perform independently. A multi-core processor may enable multiprocessing within a single physical package. Additionally or alternatively, the processor may comprise one or more processors configured in tandem via the bus to enable independent execution of instructions, pipelining and/or multithreading.

In an example embodiment, the processor 32 may be configured to execute instructions stored in the memory device 34 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a computing device) adapted for employing an embodiment of the present invention by further configuration of the processor by instructions for performing the algorithms and/or operations described herein. The processor may comprise, among other things, a clock, an arithmetic logic unit (ALU) and logic gates configured to support operation of the processor.

Meanwhile, the communication interface 36 may be any means such as a device or circuitry embodied in either hardware or a combination of hardware and software that is configured to receive and/or transmit data from/to other devices. In this regard, the communication interface may comprise, for example, an antenna (or multiple antennas) and supporting hardware and/or software for enabling communications with a wireless communication network, e.g., WLAN. As such, for example, the communication interface may comprise a communication modem and/or other hardware/software for supporting communication via cable, digital subscriber line (DSL), USB or other mechanisms.

The user interface 38 is optional in that the apparatus 30, when embodied by an ANDSF device 18, may not include a user interface, while the apparatus, when embodied by a mobile terminal 10, may include a user interface. In instances in which the apparatus includes a user interface, the user interface may be in communication with the processor 32 to receive an indication of a user input at the user interface and/or to provide an audible, visual, mechanical or other output to the user. As such, the user interface may comprise, for example, a keyboard, a mouse, a joystick, a display, a touch screen(s), touch areas, soft keys, a microphone, a speaker, or other input/output mechanisms. For example, the user interface may comprise, among other devices or elements, any or all of a speaker, a microphone, a display, and a keyboard or the like. In this regard, for example, the processor may comprise user interface circuitry configured to control at least some functions of one or more elements of the user interface, such as, for example, a speaker, ringer, microphone, display, and/or the like. The processor and/or user interface circuitry comprising the processor may be configured to control one or more functions of one or more elements of the user interface through computer program instructions (e.g., software and/or firmware) stored on a memory accessible to the processor (e.g., memory device 34, and/or the like).

In order to reduce the reliance upon cellular networks for data and other services and to utilize white space channels that are available in a manner that does not undesirably increase the signaling required of the mobile terminal 10 and the power consumed by the mobile terminal, a method, apparatus 30 and computer program product are provided in order to obtain white space information and to provide that white space information to the mobile terminal. As generally shown in FIG. 1 and as described in more detail below, a network device, such as the ANDSF device 18, may communicate with a white space database 22 to obtain white space information. Although the ANDSF device may communicate directly with the white space database, the communications between the ANDSF device and the white space database may be supported by a network, 24, such as the internet, in one embodiment. This white space information may identify one or more service providers 26 that offer connectivity utilizing the white space spectrum as well as information regarding one or more white space channels that are available via the one or more service providers. The ANDSF device may provide the white space information to the mobile terminal which may, in turn, determine whether to utilize the white space channel that is available from a respective service provider. If the mobile terminal does utilize the white space channel that is available from a respective service provider, the mobile terminal may reduce its reliance upon other access networks 14, such as a cellular access network, for data and other services, thereby improving, among other things, overall system capacity.

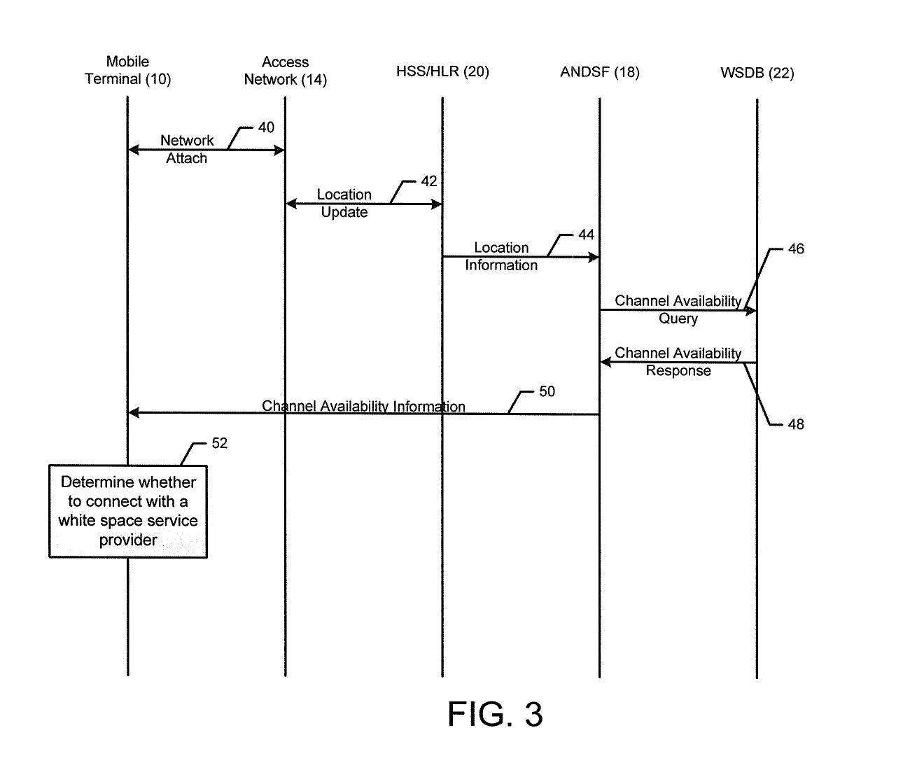

As shown by signal 40 in FIG. 3, a mobile terminal 10 may initially attach to an access network 14, such as a cellular radio access network. Via the access network, the mobile terminal may access the core network 12 and communicate therewith. During the attachment of the mobile terminal to the access network, the access network may obtain information regarding the location of the mobile terminal, such as based upon the base station 16 that is supporting the mobile terminal, and may provide information regarding the location of the mobile terminal to the core network and, more particularly to the HSS/HLR 20, as shown by signal 42 of FIG. 3. The HSS/HLR may make the information regarding the location of the mobile terminal available to the ANDSF device 18, such as either by pushing the location information to the ANDSF device or by providing the location information in response to a request by the ANDSF device. See signal 44 of FIG. 3. In this regard, the ANDSF device of one embodiment may query the HSS/HLR for location information relating to the mobile terminal on a periodic basis or in accordance with some other predefined schedule. Alternatively, the HSS/HLR may provide location information regarding the mobile terminal periodically or in accordance with some other predefined schedule. Still further, the HSS/HLR may be configured to provide location information regarding the mobile terminal in an instance in which the location of the mobile terminal is determined by the HSS/HLR to have changed. In another embodiment, one or more parameters may be predefined relating to the conditions under which the HSS/HLR should provide location information to the ANDSF device. For example, a predefined region may be established about the current location of the mobile terminal and the HSS/HLR may be configured to only provide an update to the location information associated with the mobile terminal in an instance in which the mobile terminal is determined by the HSS/HLR to have advanced beyond the predefined region. Although the location information may be provided in various manners, the ANDSF device of one embodiment may receive the location information from the HSS/HLR and may, in turn, determine the latitude and longitude and coordinates of the mobile terminal based upon the location information.

The ANDSF device 18 may also be configured to query the white space database 22 regarding the availability of one or more white space channels, that is, the availability of one or more white space frequency bands. See signal 46 of FIG. 3. The determination as to whether a white space channel is available may be dependent upon the location of the mobile terminal 10 since one white space channel may be available within one geographic region, but not available within another geographic region. Thus, the query of the white space database may include an indication of the location of the mobile terminal. The ANDSF device may query the white space database in response to an inquiry by the mobile terminal, on a periodic basis or in some other manner, such as in response to a determination that the location of the mobile terminal has changed. For example, upon the mobile terminal initially attaching to the access network 14, the ANDSF device may query the white space database for one or more white space channels that are available at the current location of the mobile terminal. Thereafter, upon a determination that the location of the mobile terminal has changed, the ANDSF device may again query the white space database for one or more white space channels that are then available at the current location of the mobile terminal.

As shown by signal 48 of FIG. 3, the white space database 22 may provide, in response to the query, information regarding the availability of one or more white space channels, such as television white space channels. The ANDSF device 18 may also determine one or more service providers 26 that offer connectivity utilizing one or more of the white space channels that are determined to be available at the location of the mobile terminal 10. In this regard, the response provided by the white space database may also provide information regarding one or more service providers that offer connectivity utilizing a white space channel that is available at the location of the mobile terminal. Alternatively, the ANDSF device may determine one or more service providers that offer connectivity utilizing a white space channel that is available following receipt of the white space information relating to the available white space channel and independent of the white space database. For example, the ANDSF may include or otherwise have access to a database of service providers as well as the white space channels supported by the respective service providers and the geographic regions in which the respective service providers offer connectivity services utilizing the white space channels.

Based upon the channel availability response from the white space database 22 and, in some embodiments, additional white space information regarding the service providers 26 that offer connectivity utilizing one or more of the white space channels that are available, the ANDSF device 18 may provide channel availability information to the mobile terminal 10. See signal 50 of the FIG. 3. The channel availability information may identify the white space channels that are currently available at the location of the mobile terminal as well as the service provider(s) that support connectivity utilizing one or more of the white space channels that are currently available at the location of the mobile terminal.

The mobile terminal 10 may then determine whether to utilize a white space channel that is available and is supported by a service provider in the location at which the mobile terminal currently is positioned. See block 52 of FIG. 3. If the mobile terminal does utilize the white space channel that was available, the mobile terminal may discontinue or at least reduce its usage of other access networks 14, such as cellular access networks, for data and other services.

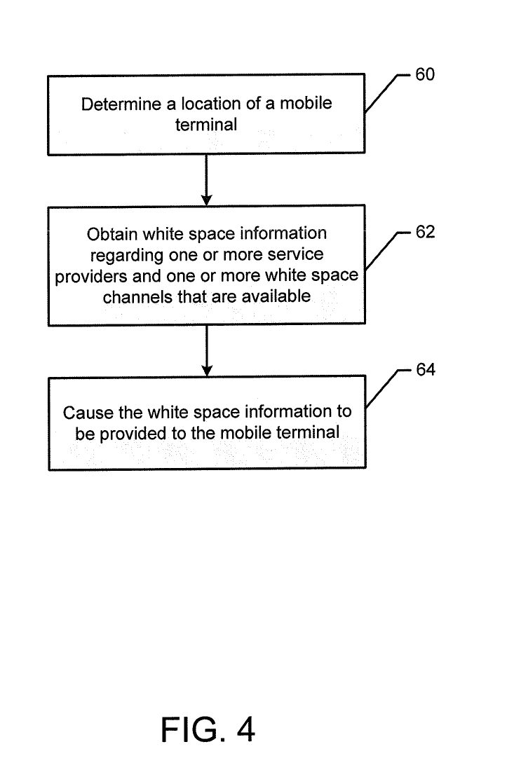

Referring now to FIG. 4, the operations performed by an apparatus 30 embodied by a network device, such as an ANDSF device 18, and that is specifically configured in accordance with an example embodiment of the present invention are illustrated. Referring now to block 60, an apparatus embodied by, for example, the ANDSF device may include means, such as the processor 32 or the like, for determining a location of a mobile terminal 10. As described above, location information relating to the mobile terminal may be received from an HSS/HLR 20. The location information provided by the HSS/HLR may be further processed by the ANDSF device and, in one embodiment, the latitude and longitude coordinates of the mobile terminal may be determined, such as by the processor, based upon the location information provided by the HSS/HLR.

The apparatus 30 embodied, for example, by the ANDSF device 18 may also include means, such as the processor 32, the communication interface 36 or the like, for obtaining, based upon the location of the mobile terminal 10, white space information, such as television white space information. See block 62 of FIG. 4. In this regard, the apparatus embodied by the ANDSF device, such as the processor, the communication interface or the like, may issue a channel availability query 46 to the white space database 22 so as to solicit information regarding one or more white space channels, e.g., television white space channels, that are available via one or more service providers 26 at the current location of the mobile terminal. The ANDSF device may interact with the white space database in various manners, but, in one embodiment, is configured to interact with the white space database using a database query/response protocol, such as the Internet Engineering Task Force (IETF) Protocol to Access White Space database (PAWS). The channel availability response 48 provided by the white space database may include the information regarding the one or more white space channels, e.g., television white space channels, that are available at the current location of the mobile terminal. In one embodiment, the channel availability response provided by the white space database may also provide information regarding one or more service providers that offer connectivity utilizing the white space spectrum and, more particularly, utilizing one or more of the white space channels that are available at the current location of the mobile terminal. In another embodiment, however, the channel availability response provided by the white space database does not include information regarding the service providers that offer connectivity utilizing the white space spectrum. In this embodiment, the apparatus embodied by the ANDSF device, such as the processor, the communication interface or the like, may obtain the information regarding the one or more service providers that offer connectivity utilizing the white space spectrum in a manner that is independent of the white space database. For example, the ANDSF device may include or have access to a database that identifies one or more service providers that offer connectivity utilizing the white space spectrum. In this embodiment, the database may identify the white space channels, that is, the white space frequency bands, supported by each of the service providers as well as the geographic location within which the service provider provides support for the respective white space channels.

Since the white space channels that are available is dependent upon the location of the mobile terminal 10 and the availability of the white space channels at that location, the channel availability query 46 provided by the ANDSF device 18 includes information regarding the location of the mobile terminal. As such, the white space database 22 may generate the channel availability response 48 including the information regarding the one or more television white space channels that are available based upon the location of the mobile terminal by ensuring that the one or more television white space channels are available at the location of the mobile terminal.

The apparatus 30 embodied, for example, by the ANDSF device 18 also include means, such as the processor 32, the communication interface 36 or the like, for causing the white space information to be provided to the mobile terminal 10. See block 64 of FIG. 4. In this regard, the white space information may be provided to the mobile terminal via the access network 14, such as a cellular access network, via which the mobile terminal is in communication with the core network 12 including the ANDSF device. The white space information includes information regarding one or more service providers 26 that offer connectivity utilizing the white space spectrum and information regarding one or more white space channels that are available via the one or more service providers. While the white space information may be provided to the mobile terminal utilizing various protocols, the white space information may be provided in one embodiment utilizing a device management protocol, such as Open Mobile Alliance-Device Management (OMA-DM) protocol.

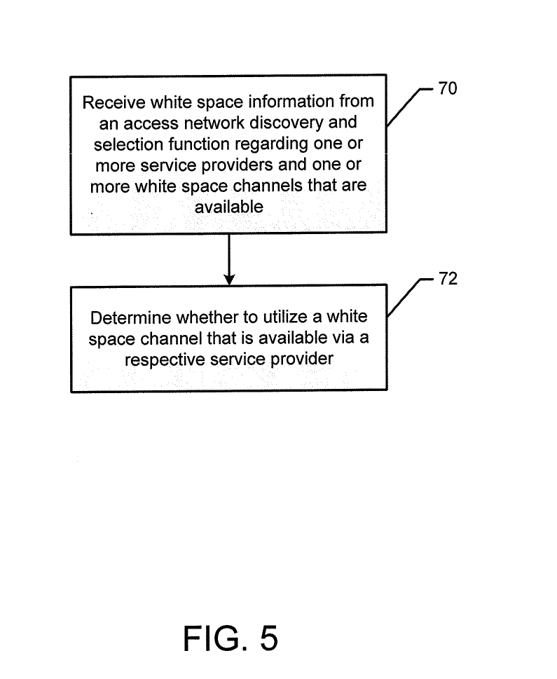

Referring now to FIG. 5 which depicts the operations from the perspective of the mobile terminal 10, an apparatus 30 embodied by the mobile terminal may include means, such as the processor 32, the communications interface 36 or the like, for receiving white space information, e.g., television white space information, from the ANDSF device 18. As described above, the white space information includes information regarding one or more service providers 26 that offer connectivity utilizing a white space spectrum and information regarding one or more channels that are available via the one or more service providers. While the mobile terminal may receive the white space information in various manners, the mobile terminal of one embodiment may receive the white space information via an access network 14, such as a cellular access network, with which the mobile terminal is in communication with the core network 12 including the ANDSF device. Additionally, while the mobile terminal may receive the white space information in accordance with various protocols, the apparatus embodied by the mobile terminal of one embodiment, such as the processor, the communications interface or the like, may be configured to receive the white space information utilizing a device management protocol, such as an OMA-DM protocol.

The apparatus 30 embodied by the mobile terminal 10 may also include means, such as the processor 22 or the like, for determining whether to utilize a white space channel, e.g., a television white space channel, that is available via a respective service provider 26. In this regard, the apparatus embodied by the mobile terminal, such as the processor, may determine whether to utilize a white space channel that is available instead of or in addition to another access network 14, such as a cellular radio access network, such as for data or other services. In instances when the mobile terminal does determine that an available white space channel should be utilized, the apparatus embodied by the mobile terminal, such as the processor, communications interface or the like, may be cause an inquiry to be sent to the respective white space service provider to initiate the establishment of communications via the white space channel that is available. As such, the reliance by the mobile terminal upon other access networks, such as cellular radio access network, and the utilization of those other access networks for data and other services may be reduced, thereby improving overall network capacity. Additionally, the utilization by a mobile terminal of a white space channel that is available may also permit the mobile terminal to utilize data and other services via the white space channel and to avoid running into limits imposed or charges levied by the network operators of other access networks in conjunction with data services or the like.

By utilizing the ANDSF or other network devices as a proxy for the mobile terminal 10 in order to obtain and provide the white space information, the signaling that may otherwise be required of the mobile terminal to obtain the white space information is reduced. As such, the signaling load upon the access network 14 is advantageously reduced. Correspondingly, the power consumed by the mobile terminal in conjunction with obtaining the white space information may also be advantageously reduced.

As described above, FIGS. 4 and 5 are flowcharts of a method, apparatus and program product from the perspective of a network device, such as an ANDSF device 18, and a mobile terminal 10, respectively, according to example embodiments of the invention. It will be understood that each block of the flowchart, and combinations of blocks in the flowcharts, may be implemented by various means, such as hardware, firmware, processor, circuitry and/or other device associated with execution of software including one or more computer program instructions. For example, one or more of the procedures described above may be embodied by computer program code. In this regard, the computer program code which embodies the procedures described above may be stored by a memory device 34 of an apparatus 30 employing an embodiment of the present invention and executed by a processor 32 in the apparatus. As will be appreciated, any such computer program code may be loaded onto a computer or other programmable apparatus (e.g., hardware) to produce a machine, such that the resulting computer or other programmable apparatus embody a mechanism for implementing the functions specified in the flowchart blocks. These computer program code may also be stored in a non-transitory computer-readable storage memory (as opposed to a transmission medium such as a carrier wave or electromagnetic signal) that may direct a computer or other programmable apparatus to function in a particular manner, such that the code stored in the computer-readable memory produce an article of manufacture the execution of which implements the function specified in the flowchart blocks. The computer program code may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 4 and 5, when executed, convert a computer or processing circuitry into a particular machine configured to perform an example embodiment of the present invention. Accordingly, the operations of FIGS. 4 and 5 define an algorithm for configuring a computer or processing circuitry (e.g., processor) to perform an example embodiment. In some cases, a general purpose computer may be configured to perform the functions shown in FIGS. 4 and 5 (e.g., via configuration of the processor), thereby transforming the general purpose computer into a particular machine configured to perform an example embodiment.

Accordingly, blocks of the flowcharts support combinations of means for performing the specified functions, combinations of operations for performing the specified functions and program instructions for performing the specified functions. It will also be understood that one or more blocks of the flowcharts, and combinations of blocks in the flowcharts, can be implemented by special purpose hardware-based computer systems which perform the specified functions or operations, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order, including concurrently, and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
determining, with a processor, a location of a mobile terminal;
based on the location of the mobile terminal, obtaining white space information with an access network discovery and selection function device regarding one or more service providers that offer connectivity utilizing a white space spectrum and information regarding one or more white space channels that are available via the one or more service providers; and
causing the white space information to be provided from the access network discovery and selection function device to the mobile terminal.

2. A method according to claim 1 wherein obtaining white space information comprises:
causing a query, including the location of the mobile terminal, to be issued to a white space database; and
in response to the query, receiving from the white space database the information regarding one or more white space channels that are available at the location of the mobile terminal.

3. A method according to claim 2 wherein obtaining white space information further comprises receiving the information regarding one or more service providers that offer connectivity via the one or more white space channels that are available at the location of the mobile terminal, wherein the information regarding the one or more service providers is also received from the white space database in response to the query.

4. A method according to claim 2 wherein obtaining white space information further comprises obtaining the information regarding one or more service providers that offer connectivity via the one or more white space channels that are available at the location of the mobile terminal following receipt of the information from the white space database regarding the one or more white space channels that are available at the location of the mobile terminal, wherein the information regarding the one or more service providers is obtained independent of the white space database.

5. A method according to claim 1 wherein determining the location of the mobile terminal comprises receiving information regarding the location of the mobile terminal from at least one of a home subscriber server or a home location register.

6. A method according to claim 5 wherein determining the location of the mobile terminal further comprises determining latitude and longitude coordinates for the mobile terminal based upon the information regarding the location of the mobile terminal from at least one of the home subscriber server or the home location register.

7. A method according to claim 1 wherein causing the white space information to be provided to the mobile terminal comprises causing the white space information to be provided to the mobile terminal utilizing a device management protocol.

8. An apparatus comprising:
at least one processor; and
at least one memory including computer program code, the at least one memory and the computer program code configured to, with the at least one processor, cause the apparatus at least to:
determine a location of a mobile terminal;
based on the location of the mobile terminal, obtain white space information with an access network discovery and selection function device regarding one or more service providers that offer connectivity utilizing a white space spectrum and information regarding one or more white space channels that are available via the one or more service providers; and
cause the white space information to be provided from the access network discovery and selection function device to the mobile terminal.

9. An apparatus according to claim 8 wherein the at least one memory and the computer program code are configured to, with the at least one processor, cause the apparatus to obtain television white space information by:
causing a query, including the location of the mobile terminal, to be issued to a white space database; and
in response to the query, receiving from the white space database the information regarding one or more white space channels that are available at the location of the mobile terminal.

10. An apparatus according to claim 9 wherein the at least one memory and the computer program code are configured to, with the at least one processor, cause the apparatus to obtain white space information by receiving the information regarding one or more service providers that offer connectivity via the one or more white space channels that are available at the location of the mobile terminal, wherein the information regarding the one or more service providers is also received from the white space database in response to the query.

11. An apparatus according to claim 9 wherein the at least one memory and the computer program code are configured to, with the at least one processor, cause the apparatus to obtain white space information by obtaining the information regarding one or more service providers that offer connectivity via the one or more white space channels that are available at the location of the mobile terminal following receipt of the information from the white space database regarding the one or more white space channels that are available at the location of the mobile terminal, wherein the information regarding the one or more service providers is obtained independent of the white space database.

12. An apparatus according to claim 10 wherein the at least one memory and the computer program code are configured to, with the at least one processor, cause the apparatus to determine the location of the mobile terminal by receiving information regarding the location of the mobile terminal from at least one of a home subscriber server or a home location register.

13. An apparatus according to claim 8 wherein the apparatus is embodied by the access network discovery and selection function device.

14. An apparatus according to claim 8 further comprising a communication interface configured to communicate with the mobile terminal.

15. A computer program product comprising computer executable program code stored on a non-transitory computer readable storage medium, the computer executable program code being configured, upon execution, to:
determine a location of a mobile terminal;
based on the location of the mobile terminal, obtain white space information with an access network discovery and selection function device regarding one or more service providers that offer connectivity utilizing a white space spectrum and information regarding one or more white space channels that are available via the one or more service providers; and
cause the white space information to be provided from the access network discovery and selection function device to the mobile terminal.

16. A computer program product according to claim 15 wherein the computer executable program code configured to obtain white space information comprises computer executable program code configured to:
cause a query, including the location of the mobile terminal, to be issued to a white space database; and
in response to the query, receive from the white space database the information regarding one or more white space channels that are available at the location of the mobile terminal.

17. A computer program product according to claim 16 wherein the computer executable program code configured to obtain white space information further comprises computer executable program code configured to receive the information regarding one or more service providers that offer connectivity via the one or more white space channels that are available at the location of the mobile terminal, wherein the information regarding the one or more service providers is also received from the white space database in response to the query.

18. A computer program product according to claim 16 wherein the computer executable program code configured to obtain white space information further comprises computer executable program code configured to obtain the information regarding one or more service providers that offer connectivity via the one or more white space channels that are available at the location of the mobile terminal following receipt of the information from the white space database regarding the one or more white space channels that are available at the location of the mobile terminal, wherein the information regarding the one or more service providers is obtained independent of the white space database.

19. A computer program product according to claim 15 wherein the computer executable program code configured to determine the location of the mobile terminal comprises computer executable program code configured to receive information regarding the location of the mobile terminal from at least one of a home subscriber server or a home location register.

20. A computer program product according to claim 19 wherein the computer executable program code configured to determine the location of the mobile terminal further comprises computer executable program code configured to determine latitude and longitude coordinates for the mobile terminal based upon the information regarding the location of the mobile terminal from at least one of the home subscriber server or the home location register.
